(19) United States
(12) Patent Application Publication
(10) Pub. No.: US 2024/0054546 A1
(43) Pub. Date: Feb. 15, 2024

(54) USER CONTEXT-BASED CONTENT SUGGESTION AND AUTOMATIC PROVISION

(71) Applicant: Sherif Gobran, Pomona, CA (US)

(72) Inventor: Sherif Gobran, Pomona, CA (US)

(21) Appl. No.: 17/884,915

(22) Filed: Aug. 10, 2022

(51) Int. Cl. G06Q 30/06

(52) U.S. Cl. CPC G06Q 30/0631

(57) ABSTRACT

User context-based content suggestion and automatic provision methods, systems, and computer-readable media are described.

Some implementations relate generally to media applications, and in particular, to systems and methods for a user context-based content suggestion and automatic provision application.

### BACKGROUND

Users of devices capable of providing content such as playing media files (e.g., music, podcasts, audio books, videos, Internet radio stations, etc.) or other content, or utilizing services or products may prefer certain content, services, or products in a given context and different ones in another context. Some conventional systems do not take user context into account. Accordingly, a need may exist for a user context-based content suggestion and automatic provision application.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method comprising obtaining user context data, and taking an action based on the user context data, wherein the action includes one of generating a media suggestion based on the user context data or automatically provisioning media based on the user context data, and wherein the action is automatically generated by a model trained to suggest or automatically provision media based on user context data.

In some implementations, the method can further include obtaining updated user context data, determining whether a change has occurred between the user context data and the updated user context data by comparing the user context data with the updated user context data, and taking a subsequent action based on the updated user context data, wherein the subsequent action includes one of generating a media suggestion based on the user context data or automatically provisioning media based on the user context data, and wherein the subsequent action is automatically generated by a model trained to suggest or automatically provision media based on user context data.

In some implementations, the user context data includes The user context can include one or more of user location, time, date, day of week, calendar items, proximity of other users, online check in or posting, purchases, type of conveyance, movement or gestures, a transition from context to context, navigation use, navigation destination, or navigation point of origin. In some implementations, the user context is obtained from one or more sub-systems within a user device. In some implementations, the user context is obtained from an external device.

In some implementations, the media suggestion includes one or more media items that a user is likely to desire to be played based on the user context. In some implementations, the media suggestion is based on previous media or playlists corresponding to the user context. In some implementations, the media suggestion is based on user confirmation or changing of suggested or automatically played media within the user context. In some implementations, the automatic provisioning includes automatically playing a media item based on the user context.

Some implementations can include a computer-implemented method comprising obtaining one or more content types, obtaining one or more user context signals, providing the one or more content types, one or more content options, and one or more user context signals to a user context-based content suggestion and automatic provision model; and generating, using a user context-based content suggestion and automatic provision model, a suggestion or an automatic provision. In some implementations, the one or more content types include media content virtual content, or content that corresponds to a physical product or service. The method can also include obtaining one or more content options corresponding to respective content types.

In some implementations, the one or more user context signals include current or previous user context signals. In some implementations, the one or more user context signals include one or more of user device signals or user physiology data gathered by a sensor. In some implementations, the one or more user context signals include signals to automatically determine the context of a user or another person associated with a user in order to automatically suggest or automatically provide content or an electronic or physical service or product associated with the content.

In some implementations, the one or more user context signals include one or more of location data, calendar data, time of day, date, weekday, holiday, device usage data. In some implementations, the one or more user context signals include one or more of mood signals, heart rate, blood pressure, or user speech characteristics. In some implementations, the model is configured to suggest or automatically play music, or a music playlist based on previous sections in a similar user context. In some implementations, the model is configured to suggest an order based on previous selections and current context of the user such as location, or automatically prepare an order for the user that the user can confirm to complete. In some implementations, the model is configured to gather data about the user context in which selections were made in order to permit the model to adapt over time to user preferences within a given context.

### BRIEF DESCRIPTION OF THE DRAWINGS

FIG. 1 is a block diagram of an example system and a network environment which may be used for one or more implementations described herein.

FIG. 2 is a flowchart of an example method for a user context-based media application in accordance with some implementations.

FIG. 3 is a block diagram of an example computing device which may be used for one or more implementations described herein.

FIG. 4 is a block diagram showing an example user context-based content suggestion and/or automatic provision model in accordance with some implementations.

### DETAILED DESCRIPTION

Some implementations include user context-based media application methods and systems.

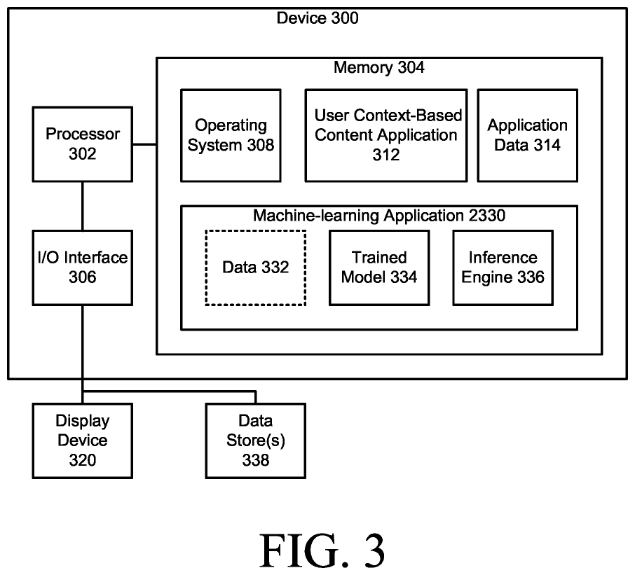

When performing user context-based media application functions, it may be helpful for a system to suggest and/or to make predictions about the desired media to be played by a user in a given user context. To make predictions or suggestions, a probabilistic model (or other model as described below in conjunction with FIG. 3) can be used to make an inference (or prediction) about aspects of media such as specific media items (e.g., a song or multiple songs) to suggest or automatically play or groups of media items (e.g., an album or channel) to suggest or automatically play. Accordingly, it may be helpful to make an inference regarding a probability that in a given user context, a user would prefer a certain media. Other aspects can be predicted or suggested as described below.

The inference based on the probabilistic model can include predicting desired media in accordance with user context (or other data) analysis and confidence score as inferred from the probabilistic model. The probabilistic model can be trained with data including previous media selections and corresponding user context data. Some implementations can include generating media suggestions or automatically playing media based on user context.

The systems and methods provided herein may overcome one or more deficiencies of some conventional media systems and methods. For example, conventional media systems and methods may not take user context into account when automatically suggesting or playing media.

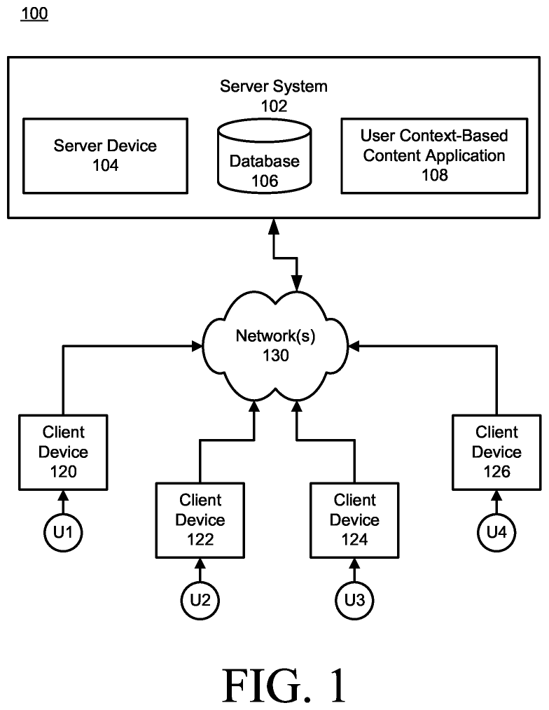

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106, and a user context-based media application 108 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, database 106, and user context-based media application 108, and shows four blocks for client devices 120, 122, 124, and 126. Some blocks (e.g., 102, 104, 106, and 108) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, smart speakers, earphones, headsets, vehicle entertainment systems, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide user context-based media application functions.

Various implementations of features described herein can use any type of system and/or service. Any type of electronic device can make use of features described herein. Some implementations can provide one or more features described herein on client or server devices disconnected from or intermittently connected to computer networks.

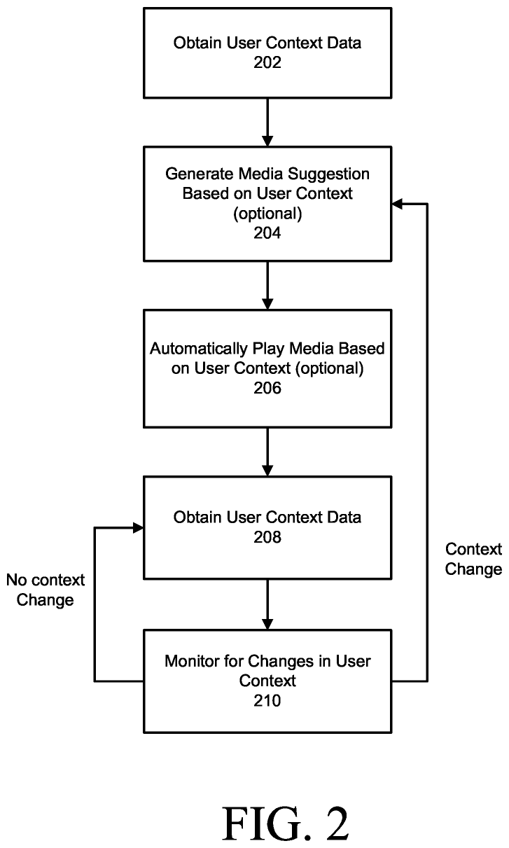

FIG. 2 is a flowchart showing an example user context-based media application method in accordance with some implementations. Processing begins at 202, where a user context is obtained. The user context can include one or more of user location, time, date, day of week, calendar items, proximity of other users, online check in or posting, purchases, type of conveyance (car, walking, bus, train, plane), movement or gestures (jogging, running, etc.), a transition from context to context, navigation use, navigation destination, navigation point of origin, or the like. The user context can be obtained from one or more sub-systems within a user device and/or from an external device. Processing continues to 204.

At 204, a media suggestion is optionally automatically generated based on the user context. For example, the user context can be provided to a machine learning model that has been trained to receive user context information as input and provide a prediction of one or more media items that a user is likely to desire to be played in that context. The media suggestion can also be based on previous media or playlists corresponding to the user context, and/or user confirmation or changing of suggested or automatically played media within the user context. Processing continues to 206.

At 206, a media item (e.g., song, video, podcast, audio file, radio station, media playlist, etc.) is optionally automatically played based on the user context. For example, the user context can be provided to a machine learning model that has been trained to receive user context information as input and provide a prediction of one or more media items that a user is likely to desire to be played in that context. Processing continues to 208.

At 208, the user context is obtained again. Processing continues to 210.

At 210, the user context is monitored for changes. If there are no changes, processing continues to 208. If there have been one or more changes in the user context, processing continues back to 204.

FIG. 3 is a block diagram of an example device 300 which may be used to implement one or more features described herein. In one example, device 300 may be used to implement a client device, e.g., any of client devices 120-126 shown in FIG. 1. Alternatively, device 300 can implement a server device, e.g., server device 104, etc. In some implementations, device 300 may be used to implement a client device, a server device, or a combination of the above. Device 300 can be any suitable computer system, server, or other electronic or hardware device as described above.

One or more methods described herein (e.g., FIG. 2) can be run in a standalone program that can be executed on any type of computing device, a program run on a web browser, a mobile application (“app”) run on a mobile computing device (e.g., cell phone, smart phone, tablet computer, vehicle computer, smart speaker, wearable device (wristwatch, armband, jewelry, headwear, virtual reality goggles or glasses, augmented reality goggles or glasses, head mounted display, etc.), earphones, headphones, laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 300 includes a processor 302, a memory 304, and I/O interface 306. Processor 302 can be one or more processors and/or processing circuits to execute program code and control basic operations of the device 300. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 302 may include one or more co-processors that implement neural-network processing. In some implementations, processor 302 may be a processor that processes data to produce probabilistic output, e.g., the output produced by processor 302 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 304 is typically provided in device 300 for access by the processor 302 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 302 and/or integrated therewith. Memory 304 can store software operating on the server device 300 by the processor 302, including an operating system 308, machine-learning application 330, user context-based media application 310, and application data 312. Other applications may include applications such as a data display engine, web hosting engine, image display engine, notification engine, social networking engine, etc. In some implementations, the machine-learning application 330 and user context-based media application 310 can each include instructions that enable processor 302 to perform functions described herein, e.g., some or all of the methods of FIG. 2.

The machine-learning application 330 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a user context-based media application 310 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 330 may utilize Bayesian classifiers, support vector machines, neural networks, or other learning techniques. In some implementations, machine-learning application 330 may include a trained model 334, an inference engine 336, and data 332. In some implementations, data 332 may include training data, e.g., data used to generate trained model 334. For example, training data may include any type of data suitable for training a model for user context-based media application tasks, such as user context, media selection, labels, thresholds, etc. associated with user context-based media application described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 334, training data may include such user data. In implementations where users permit use of their respective user data, data 332 may include permitted data.

In some implementations, data 332 may include collected data such as user context and media selections. In some implementations, training data may include synthetic data generated for the purpose of training, such as data that is not based on user input or activity in the context that is being trained, e.g., data generated from simulated user context and media selections, etc. In some implementations, machine-learning application 330 excludes data 332. For example, in these implementations, the trained model 334 may be generated, e.g., on a different device, and be provided as part of machine-learning application 330. In various implementations, the trained model 334 may be provided as a data file that includes a model structure or form, and associated weights. Inference engine 336 may read the data file for trained model 334 and implement a neural network with node connectivity, layers, and weights based on the model structure or form specified in trained model 334.

Machine-learning application 330 also includes a trained model 334. In some implementations, the trained model 334 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 332 or application data 312. Such data can include, for example, user context data, e.g., when the trained model is used for user context-based media application functions. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In different implementations, the trained model 334 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 334 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 332, to produce a result.

For example, training may include applying supervised learning techniques. In supervised learning, the training data can include a plurality of inputs (e.g., user context data) and a corresponding expected output for each input (e.g., one or more labels for user context and/or media selections). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify user context labels that are associated with certain media and/or select thresholds for user context-based media application task recommendation.

In another example, a model trained using unsupervised learning may cluster words based on the use of the words in data sources. In some implementations, unsupervised learning may be used to produce knowledge representations, e.g., that may be used by machine-learning application 330. In various implementations, a trained model includes a set of weights, or embeddings, corresponding to the model structure. In implementations where data 332 is omitted, machine-learning application 330 may include trained model 334 that is based on prior training, e.g., by a developer of the machine-learning application 330, by a third-party, etc. In some implementations, trained model 334 may include a set of weights that are fixed, e.g., downloaded from a server that provides the weights.

Machine-learning application 330 also includes an inference engine 336. Inference engine 336 is configured to apply the trained model 334 to data, such as application data 312, to provide an inference. In some implementations, inference engine 336 may include software code to be executed by processor 302. In some implementations, inference engine 336 may specify circuit configuration (e.g., for a programmable processor, for a field programmable gate array (FPGA), etc.) enabling processor 302 to apply the trained model. In some implementations, inference engine 336 may include software instructions, hardware instructions, or a combination. In some implementations, inference engine 336 may offer an application programming interface (API) that can be used by operating system 308 and/or user context-based media application 310 to invoke inference engine 336, e.g., to apply trained model 334 to application data 312 to generate an inference.

Machine-learning application 330 may provide several technical advantages. For example, when trained model 334 is generated based on unsupervised learning, trained model 334 can be applied by inference engine 336 to produce knowledge representations (e.g., numeric representations) from input data, e.g., application data 312. For example, a model trained for user context-based media application tasks may produce predictions and confidences for given input information about a user context. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 336.

In some implementations, knowledge representations generated by machine-learning application 330 may be provided to a different device that conducts further processing, e.g., over a network. In such implementations, providing the knowledge representations rather than the actual data may provide a technical benefit, e.g., enable faster data transmission with reduced cost. In another example, a model trained for user context-based media tasks may produce a media signal for one or more user context data items being processed by the model.

In some implementations, machine-learning application 330 may be implemented in an offline manner. In these implementations, trained model 334 may be generated in a first stage and provided as part of machine-learning application 330. In some implementations, machine-learning application 330 may be implemented in an online manner. For example, in such implementations, an application that invokes machine-learning application 330 (e.g., operating system 308, one or more of user context-based media application 310 or other applications) may utilize an inference produced by machine-learning application 330, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 334, e.g., to update embeddings for trained model 334.

In some implementations, machine-learning application 330 may be implemented in a manner that can adapt to particular configuration of device 300 on which the machine-learning application 330 is executed. For example, machine-learning application 330 may determine a computational graph that utilizes available computational resources, e.g., processor 302. For example, if machine-learning application 330 is implemented as a distributed application on multiple devices, machine-learning application 330 may determine computations to be carried out on individual devices in a manner that optimizes computation. In another example, machine-learning application 330 may determine that processor 302 includes a GPU with a particular number of GPU cores (e.g., 1000) and implement the inference engine accordingly (e.g., as 1000 individual processes or threads).

In some implementations, machine-learning application 330 may implement an ensemble of trained models. For example, trained model 334 may include a plurality of trained models that are each applicable to same input data. In these implementations, machine-learning application 330 may choose a particular trained model, e.g., based on available computational resources, success rate with prior inferences, etc. In some implementations, machine-learning application 330 may execute inference engine 336 such that a plurality of trained models is applied. In these implementations, machine-learning application 330 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 308 or one or more other applications, e.g., user context-based media application 310.

In different implementations, machine-learning application 330 can produce different types of outputs. For example, machine-learning application 330 can provide representations or clusters (e.g., numeric representations of input data), labels (e.g., for input data that includes user context data, media selections, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 330 may produce an output video with a particular effect applied, e.g., rendered in a comic-book or particular artist's style, when trained model 334 is trained using training data from the comic book or particular artist, etc. In some implementations, machine-learning application 330 may produce an output based on a format specified by an invoking application, e.g., operating system 308 or one or more applications, e.g., user context-based media application 310. In some implementations, an invoking application may be another machine-learning application. For example, such configurations may be used in generative adversarial networks, where an invoking machine-learning application is trained using output from machine-learning application 330 and vice-versa.

Any of software in memory 304 can alternatively be stored on any other suitable storage location or computer-readable medium. In addition, memory 304 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 304 and any other type of storage (magnetic disk, optical disk, magnetic tape, or other tangible media) can be considered “storage” or “storage devices.”

I/O interface 306 can provide functions to enable interfacing the server device 300 with other systems and devices. Interfaced devices can be included as part of the device 300 or can be separate and communicate with the device 300. For example, network communication devices, storage devices (e.g., memory and/or database 106), and input/output devices can communicate via I/O interface 306. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 306 can include one or more display devices 320 and one or more data stores 338 (as discussed above). The display devices 320 that can be used to display content, e.g., a user interface of an output application as described herein. Display device 320 can be connected to device 300 via local connections (e.g., display bus) and/or via networked connections and can be any suitable display device. Display device 320 can include any suitable display device such as an LCD, LED, or plasma display screen, CRT, television, monitor, touchscreen, 3-D display screen, or other visual display device. For example, display device 320 can be a flat display screen provided on a mobile device, multiple display screens provided in a goggles or headset device, or a monitor screen for a computer device. Display device 320 can also include an audio output device.

The I/O interface 306 can interface to other input and output devices. Some examples include one or more cameras which can capture images. Some implementations can provide a microphone for capturing sound (e.g., as a part of captured images, voice commands, etc.), audio devices for outputting sound, or other input and output devices.

For ease of illustration, FIG. 3 shows one block for each of processor 302, memory 304, I/O interface 306, and software blocks 308, 310, and 330. These blocks may represent one or more processors or processing circuitries, operating systems, memories, I/O interfaces, applications, and/or software modules. In other implementations, device 300 may not have all of the components shown and/or may have other elements including other types of elements instead of, or in addition to, those shown herein. While some components are described as performing blocks and operations as described in some implementations herein, any suitable component or combination of components of environment 100, device 300, similar systems, or any suitable processor or processors associated with such a system, may perform the blocks and operations described.

In some implementations, logistic regression can be used for personalization (e.g., personalizing user context-based media suggestions based on a user's pattern of media activity). The mapping (or calibration) from ICA space to a predicted precision within the user context media space can be performed using a piecewise linear model.

In some implementations, the user context-based media application system could include a machine-learning model (as described herein) for tuning the system (e.g., selecting user context labels and corresponding thresholds) to potentially provide improved accuracy. Inputs to the machine learning model can include ICA labels, a descriptor vector that describes context or media and includes semantic information about user context-based media. Example machine-learning model input can include labels for a simple implementation and can be augmented with descriptor vector features for a more advanced implementation. Output of the machine-learning module can include a prediction of media a user would prefer for a given user context.

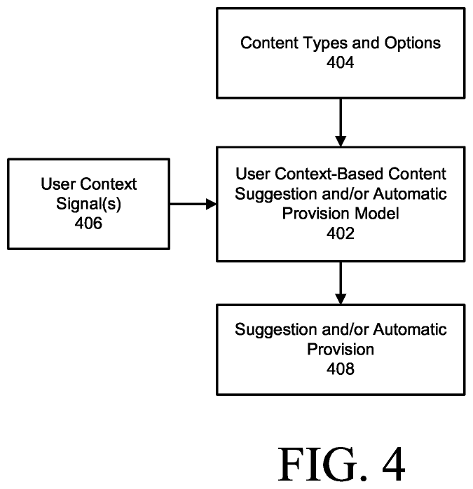

FIG. 4 is a block diagram showing an example user context-based content suggestion and/or automatic provision model in accordance with some implementations. In particular, the model 402 can include a machine learning model or other suitable model for generating predictions, suggestions, or automatic provisioning actions for one or more content items based on user context.

The model 402 can receive content types and options 404 as input. The content types can include media such as music, audio, video, documents, images, etc. The content types can also include content that is virtual or content that corresponds to a physical product or service such as food available for delivery or pick up, places to go, movies available for in theater or streaming, activities such as concerts, events, venues, content related to products, etc. In general, any content type and associated options for which automatic suggestion or provisioning may be desired can be used. The content options can include any options or parameters associated with the content or with a service or product represented by the content.

The model 402 can also receive one or more user context signals 406. The one or more user context signals can include current or previous user context signals (e.g., used for training the model 402). The one or more user context signals can include, but are not limited to, user device signals (e.g., location data, calendar data, time of day, date, weekday, holiday, device usage data, etc.), user physiology data gathered by a sensor (e.g., mood signals, heart rate, blood pressure, user speech characteristics, etc.), or the like. In general, any signal that can be determined about the context of a user or another person associated with a user can be used to suggest or automatically provide content or an electronic or physical service or product associated with the content.

Based on the content types and options 404 and user context signal(s) 406, the model 402 can generate one or more content suggestions and/or automatic provision actions. In general, the model 402 can make a prediction about what content a user may wish to consume or what services or products associated with content that a user may wish to consume based on the content types and options 404 and the user context signal(s) 406. Thus, the model 402 can make suggestions or automatically take actions to anticipate what a user may desire within a given context of the user. For example, when a user is engaged in exercise or other physical activities such as sports, the user may typically desire a certain type or music or playlist of music, and the model 402 can suggest or automatically play the music or playlist based on the user's previous sections in the same or a similar user context. In another example, when a user is driving a vehicle, the user may typically desire a certain type of music or audio content and the model 402 can suggest or automatically play the music or audio content based on the user's previous selections. In yet another example, the user may typically order food or visit a restaurant at a certain time of day (e.g., for breakfast, lunch, or dinner) and the model 402 can suggest a food order or restaurant (based on the user's previous selections and the current context of the user such as location) or automatically prepare an order for the user that the user can confirm. The types of content, virtual services, physical services, and/or physical products that can be suggest or automatically provisioned based on user context is practically unlimited. Further, as the user engages with content selections, the model 402 can learn from those selections and gather data about the user context in which such selections were made to allow the model to adapt over time to the user's preferences within a given context.

Regarding the user context data or signals, an implementation can include an opt-in/opt-out feature whereby a user can select which, if any, user data can be used for content suggestion or automatic provision. Further, in some implementations, the user context data can be stored in the user device only and deleted once the data has been used to make a content suggestion or automatic provision. Also, in cases where user context data may be sent to a server for processing such as training a model or making a content suggestion, the user data can be made anonymous by removing any personally identifiable information of the user. In some implementations, the user context data can be processed and/or stored in accordance with any applicable laws or rules for a given jurisdiction regarding user data collection and retention.

One or more methods described herein (e.g., FIG. 2 or 4) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
obtaining user context data; and
taking an action based on the user context data, wherein the action includes one of generating a media suggestion based on the user context data or automatically provisioning media based on the user context data, and wherein the action is automatically generated by a model trained to suggest or automatically provision media based on user context data.

2. The computer-implemented method of claim 1, further comprising:
obtaining updated user context data;
determining whether a change has occurred between the user context data and the updated user context data by comparing the user context data with the updated user context data; and
taking a subsequent action based on the updated user context data, wherein the subsequent action includes one of generating a media suggestion based on the user context data or automatically provisioning media based on the user context data, and wherein the subsequent action is automatically generated by a model trained to suggest or automatically provision media based on user context data.

3. The computer-implemented method of claim 1, wherein the user context data includes The user context can include one or more of user location, time, date, day of week, calendar items, proximity of other users, online check in or posting, purchases, type of conveyance, movement or gestures, a transition from context to context, navigation use, navigation destination, or navigation point of origin.

4. The computer-implemented method of claim 1, wherein the user context is obtained from one or more sub-systems within a user device.

5. The computer-implemented method of claim 1, wherein the user context is obtained from an external device.

6. The computer-implemented method of claim 1, wherein the media suggestion includes one or more media items that a user is likely to desire to be played based on the user context.

7. The computer-implemented method of claim 1, wherein the media suggestion is based on previous media or playlists corresponding to the user context.

8. The computer-implemented method of claim 1, wherein the media suggestion is based on user confirmation or changing of suggested or automatically played media within the user context.

9. The computer-implemented method of claim 1, wherein the automatic provisioning includes automatically playing a media item based on the user context.

10. A computer-implemented method comprising:
obtaining one or more content types;
obtaining one or more user context signals;
providing the one or more content types, one or more content options, and one or more user context signals to a user context-based content suggestion and automatic provision model; and
generating, using a user context-based content suggestion and automatic provision model, a suggestion or an automatic provision.

11. The computer-implemented method of claim 10, wherein the one or more content types include media content virtual content, or content that corresponds to a physical product or service.

12. The computer-implemented method of claim 10, further comprising obtaining one or more content options corresponding to respective content types.

13. The computer-implemented method of claim 10, wherein the one or more user context signals include current or previous user context signals.

14. The computer-implemented method of claim 10, wherein the one or more user context signals include one or more of user device signals or user physiology data gathered by a sensor.

15. The computer-implemented method of claim 10, wherein the one or more user context signals include signals to automatically determine the context of a user or another person associated with a user in order to automatically suggest or automatically provide content or an electronic or physical service or product associated with the content.

16. The computer-implemented method of claim 10, wherein the one or more user context signals include one or more of location data, calendar data, time of day, date, weekday, holiday, device usage data.

17. The computer-implemented method of claim 10, wherein the one or more user context signals include one or more of mood signals, heart rate, blood pressure, or user speech characteristics.

18. The computer-implemented method of claim 10, wherein the model is configured to suggest or automatically play music, or a music playlist based on previous sections in a similar user context.

19. The computer-implemented method of claim 10, wherein the model is configured to suggest an order based on previous selections and current context of the user such as location, or automatically prepare an order for the user that the user can confirm to complete.

20. The computer-implemented method of claim 10, wherein the model is configured to gather data about the user context in which selections were made in order to permit the model to adapt over time to user preferences within a given context.
